(19) United States
(12) Patent Application Publication
(10) Pub. No.: US 2005/0048345 A1
(43) Pub. Date: Mar. 3, 2005

(54) Hybrid fuel cell system with internal combustion reforming

(76) Inventor: G.B. Kirby Meacham, Shaker Heights, OH (US)

Correspondence Address: MEACHAM COMPANY, 18560 PARKLAND DRIVE, SHAKER HEIGHTS, OH, 44122, US

(21) Appl. No.: 10/654,793

(22) Filed: Sep. 3, 2003

(51) Int. Cl. H01M 8/04

(52) U.S. Cl. 429/34; 429/26

(57) ABSTRACT

The present invention is a hybrid system for generating power from hydrocarbon and alcohol fuels using a two-stage process to achieve high overall energy conversion efficiency. The first stage is a reformer and fuel cell subsystem that uses an internal combustion engine operated at an air/fuel ratio richer than stoichiometric as a partial oxidation reformer for commonly available liquid or gaseous hydrocarbon or alcohol fuels. The engine produces shaft power and a product gas mixture containing hydrogen, carbon monoxide, and traces of light hydrocarbons that is used as fuel in fuel cells to generate electric power. The second stage is a heat engine subsystem that captures heat from the reformer and fuel cell subsystem, and produces additional shaft power. In addition to efficiency, advantages include adaptability to a variety of fuels, quick system startup with immediate shaft power availability, and low emission of pollutantants.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The background of the invention includes hybrid power generation systems that utilize the unreacted fuel and waste sensible heat of a fuel cell as the heat source in a Brayton cycle engine. This combination increases the overall conversion of fuel energy to electrical energy and provides shaft power. The background further includes fuel cell systems that use internal combustion engines as chemical reactors to reform hydrocarbon fuels.

Fuel cells are electrochemical systems that generate electrical current by chemically reacting fuel gas on an anode electrode surface and oxidant gas on a cathode surface. Conventionally, the oxidant gas is oxygen or air, and the fuel gas contains hydrogen.

While fuel cell power generation systems are more efficient than other power generation systems, they still only typically convert 40% to 60% of the fuel heating value to electric power. The balance is converted to heat through several mechanisms. First, electrical resistive losses and other irreversible processes within the cells themselves generate heat that is transferred to the gas streams or removed by cooling apparatus. Second, if fuel processors are part of the system, heat leakage and irreversible processes cause net heat production. Third, fuel cells can only utilize 70% to 90% of the fuel, and must exhaust the rest as unburned gas to prevent anode oxidation damage. Consequently, the partially depleted fuel exhaust is burned to produce heat or otherwise utilized so that it is not discharged as a pollutant.

Since this waste heat is available at high temperature, particularly from high temperature fuel cells such as solid oxide fuel cells (SOFC), it is a thermodynamically attractive energy source. U.S. Pat. No. 5,693,201 by Hsu et al. exemplifies hybrid power generation systems that utilize the waste sensible heat and unutilized fuel of a fuel cell subsystem as the heat source in a Brayton cycle internal combustion engine to increase the overall conversion of fuel energy to electrical energy and shaft power. In this cycle ambient air is compressed and passed over the cathode surfaces of a fuel cell, and fuel is supplied to the anode surfaces at approximately the same elevated pressure as the cathode air. The fuel and air react through an electrolyte in the fuel cell to generate electric power. The depleted hot air and fuel streams then mix in an afterburner where the remaining fuel combusts to raise the temperature further. This hot, pressurized gas expands adiabatically through a turbine to produce shaft power. A portion of the shaft power drives the compressor, and the balance is available to generate additional electric power or for other useful purposes. Overall fuel to power conversion efficiency of 70% is cited, compared to about 50% for the fuel cell alone or 25% for the turbine alone. Further, operation of the fuel cell at elevated pressures has advantages including smaller flow passages and increased power density and efficiency.

Despite improved efficiency and other advantages, hybrid systems such as described in U.S. Pat. No. 5,693,201 encounter a fuel supply problem. Pure hydrogen is the ideal fuel for all fuel cell types, but it is not widely available at a cost competitive with conventional fuels. Further, storage and transportation involves large, heavy and costly means such as compressed gas bottles. Practical fuel cell power plants must therefore utilize commonly available and easily transported fuels including natural gas, liquefied petroleum gas (LPG), methanol, ethanol, gasoline and diesel fuel, and logistic fuel. However, to utilize these fuels, the power plant must reform the hydrocarbons and alcohols to a fuel gas suitable for the particular fuel cell application. In addition, these fuels also often contain sulfur that must be removed. Conventional processes for desulfurizing and reforming liquid and gaseous fuels are well known in the art, but have numerous shortcomings and add to the cost and complexity of power production.

Fuel reforming is based on the endothermic reaction of hydrocarbon or alcohol fuel with steam and/or CO₂, to form CO and H₂. This can be done in two ways: steam reforming or partial oxidation (POX) reforming and catalytic autothermal reforming.

Steam reformers use high temperature catalyst filled tubes heated by burners fueled by fuel cell exhaust fuel and air streams. Steam is supplied by a waste heat boiler. Heat transferred across the tube wall drives the endothermic reaction. Such systems provide the highest hydrogen yield, but tend to be large, complex, and slow to start up and respond to load changes. Further, they require sulfur removal from the feedstock to avoid catalyst poisoning.

POX reformers and catalytic autothermal reformers eliminate high temperature heat exchangers by reacting a rich mixture of fuel and air to provide the reforming heat within the gas stream. Steam is added to the hot hydrogen and carbon monoxide to cool the stream and increase hydrogen yield. Non-catalytic POX reformers operate at temperatures around 1000° C. for gasoline and up to 1400° C. for heavy hydrocarbons, necessitating special heat-resistant materials. Autothermal reformers use a catalyst to operate at temperatures under 1000° C., and may be less costly. These systems are smaller, simpler and faster responding than steam reformers, and are preferred for applications such as vehicle propulsion. Even so, there is a delay before power is available in a cold start and the feedstock must be low in sulfur if a catalyst is used.

Sulfur removal further complicates the power generation system. The method of sulfur removal selected depends on both the reforming system and the type of fuel. If the reforming reaction uses a catalyst, then the sulfur is typically removed from the feedstock prior to reforming. Hydrodesulfurization is the classic means used for liquid hydrocarbons. Hydrogen separated from the product gas stream is reacted with the fuel over the catalyst to convert the sulfur compounds to hydrogen sulfide. The hydrogen sulfide is then removed by passing the stream through a zinc oxide bed. Activated charcoal filtration is sufficient to remove sulfur from natural gas before reforming. Non-catalytic POX reformers tolerate sulfur in the fuel, and convert it to hydrogen sulfide that can be removed from the product gas with a zinc oxide bed. Heavier liquid hydrocarbons such as diesel fuel are generally the most difficult to desulfurize and reform. They tend to form soot rather than the desired product gas, and contain large amounts of sulfur. “Logistic” fuel is an extreme case. It is a low-grade, high sulfur diesel fuel that may be the only fuel available to the military in the field. Fuel cell power plants therefore require extensive fuel processing capability to operate on logistic fuel, resulting in additional size and weight. Reciprocating and turbine internal combustion engines, in contrast, operate directly on logistic fuel.

Since low temperature fuel cells can only utilize hydrogen and do not tolerate over 50 ppm CO, shift conversion and selective oxidation stages must be added to increase hydrogen and decrease CO levels. The situation is simpler for high temperature fuel cells. At 600° C. to 1000° C., CO and moderate quantities of hydrocarbons are reformed at the nickel anode surface using the steam, CO₂ and heat from the power generation reaction. The reforming process only needs to break down the heavy hydrocarbons into a mix of gasses that the SOFC can utilize directly or reform internally without soot formation. High-temperature fuel cell systems can therefore use the product gas from steam, autothermal and POX reformers directly.

Startup characteristics are often important in fuel cell power plants operating on hydrocarbon and alcohol. A certain amount of time is needed to start a reformer to generate hydrogen, and high temperature fuel cells require time to heat to operating temperature regardless of the availability of fuel. This delay necessitates an interim power source such as a battery or internal combustion engine for applications that require immediate response, such as vehicle propulsion or emergency power.

U.S. Pat. No. 6,502,533 Internal Combustion Fuel Reforming issued to this applicant describes fuel cell systems that use fuel-rich internal combustion engines as partial oxidation (POX) fuel reformers, and is incorporated in its entirety by reference. This internal combustion reforming (ICR) process offers numerous advantages including ability to reform heavy hydrocarbons, instant startup and shaft power production, and sulfur tolerance. Any type of homogeneous charge engine may be used for ICR, including two and four stroke reciprocating engines, turbines, and wankels.

Internal combustion engines utilize cycles that compress air, heat the air by reacting fuel with the oxygen in the air, and expand the heated air to produce work. The theoretical amount of fuel required to consume the oxygen in the air is termed the stoichiometric quantity. Normally a lean mixture (less than the stoichiometric quantity of fuel) is employed. It provides the most efficient and economical engine operation since almost all the fuel is reacted before it is exhausted. A rich mixture (more than the stoichiometric quantity of fuel) is less efficient. Excess fuel is discharged in the exhaust and produces no useful work in the engine. This combustion process does, however, change the composition of the excess hydrocarbon fuel into a form useful in fuel cells. Rich mixture exhaust contains hydrogen, carbon monoxide, and small amounts of hydrocarbons in addition to nitrogen and water vapor. Emissions benefits are also gained. The reducing environment created by the rich mixture suppresses oxides of nitrogen (NOX) typically produced by lean mixtures. In addition, sulfur compounds are converted to hydrogen sulfide that is relatively simple to remove from the product gas stream. The overall result of rich internal combustion engine operation with hydrocarbon fuel is shaft work and almost complete conversion of the excess fuel into useful product gas containing hydrogen and CO.

### BRIEF SUMMARY OF THE INVENTION

The present invention is a hybrid system for generating power from hydrocarbon and alcohol fuels using a two-stage process. The fuel cell subsystem comprises an internal combustion engine and fuel cell that produce electric and shaft power from hydrocarbon or alcohol fuel, together with waste heat and fuel. The hybrid stage comprises a heat engine that utilizes the waste heat and fuel from the fuel cell subsystem to produce additional shaft power. In the hybrid stage the heat engine compressor compresses ambient air from P-atmospheric to an intermediate pressure P-hybrid. The intermediate pressure air is divided into two streams. The first stream flows to the ICR where it is further compressed to a higher pressure P-reformer. Hydrocarbon or alcohol fuel in excess of stoichiometric is added to the higher pressure air and ignited to increase the mixture temperature and cause a partial oxidation reforming (POX) reaction. The resulting product gas, which includes hydrogen and carbon monoxide, is then adiabatically expanded and cooled to P-hybrid. Shaft power produced by the expansion is used to drive the ICR compressor and generate electric power or do other useful work. The product gas flows through the anode passages of a fuel cell and is electrochemically oxidized to produce electric power. The second P-hybrid air stream flows through the cathode passages of the fuel cell and is electrochemically reduced as part of the electric power production process. Only a portion of the product gas fuel energy content is consumed in the fuel cell, typically 70% to 90%, and the rest remains in the anode exhaust stream. In addition, both the anode and cathode exhaust streams are heated by the fuel cell reactions, and the cathode exhaust contains residual oxygen. The anode and cathode exhaust streams, which are still at P-hybrid, combine in an afterburner where the remaining fuel is consumed and the gas is further heated. The hot, intermediate afterburner exhaust is then adiabatically expanded and cooled to P-atmospheric in the hybrid stage heat engine expander. Shaft power produced by the expansion is used to drive the outer stage heat engine compressor and generate electric power or do other useful work.

The present invention has a number of objectives. First, it retains all the advantages of ICR fuel reforming. The high peak temperatures in the internal combustion engine cycle decompose the hydrocarbons and alcohols and hydrogenate sulfur compounds without catalysts. In particular, difficult feedstock such as “logistic” fuel may be processed. At the same time, oxide of nitrogen formation is strongly suppressed through the reducing effect of excess fuel. Second, thermodynamic advantages are gained. The ICR produces shaft power and reduces the gas temperature so that the product gas temperature is on the order of 700° C. The hybrid stage heat engine captures sensible heat and fuel energy in the form of additional shaft power. Like the electric power, shaft power is thermodynamically the highest grade of energy, and contributes to the overall system efficiency. Third, system operation is enhanced. Internal combustion engines start in seconds and, while the system warms up, produce immediate shaft power that may be used for a number of purposes including vehicle propulsion and emergency electric power generation. The hot exhaust serves to heat the balance of the fuel processing system and start the electrochemical power generation process. The internal combustion engine may be controlled such that startup operation is near stoichiometric to maximize shaft power output and minimize fuel waste and exhaust pollution while the system is heated, and then shifted to rich operation. In general, the internal combustion engine facilitates system control. Rotational speed, air flow and fuel-air ratio may be varied over a wide range to control the composition and flow rate of product gas. Further, operation of the ICR and fuel cell at elevated pressures has advantages including increased power density and efficiency and smaller flow passages in both the internal combustion engine and fuel cell. Fourth, the invention utilizes mature, low cost internal combustion engine technology that is supported by a ubiquitous manufacturing, service and fuel supply infrastructure. This facilitates earlier widespread fuel cell application with the attendant environmental and energy conservation benefits.

In a preferred embodiment the hybrid stage heat engine is a Brayton cycle turbomachine. It may, however, be any form of heat engine that captures ICR and fuel cell sensible heat and fuel energy in the form of high value shaft power. In a preferred embodiment the ICR is a rich-running turbomachine or piston engine, and the fuel cell is a high temperature type such as solid oxide that is inherently compatible with the ICR product gas. The ICR may, however, use any type of internal combustion engine adapted to operate with mixtures richer than stoichiometric. Likewise the fuel cell system may be any type that includes appropriate gas processing modules to allow use of the ICR product gas.

In summary, integration of a hybrid stage heat engine with an ICR-fuel cell subsystem results in increased power plant efficiency while retaining the quick starting, fast response and broad fuel composition tolerance of ICR-fuel cell systems.

Upon examination of the following detailed description the novel features of the present invention will become apparent to those of ordinary skill in the art or can be learned by practice of the present invention. It should be understood that the detailed description of the invention and the specific examples presented, while indicating certain embodiments of the present invention, are provided for illustration purposes only. Various changes and modifications within the spirit and scope of the invention will become apparent to those of ordinary skill in the art upon examination of the following detailed description of the invention and claims that follow.

### BRIEF DESCRIPTION OF THE SEVERAL VIEWS OF THE DRAWING

The appended claims set forth those novel features that characterize the invention. However, the invention itself, as well as further objects and advantages thereof, will best be understood by reference to the following detailed description of preferred embodiments taken in conjunction with the accompanying drawings, where like reference characters identify like elements throughout the various figures, in which:

FIG. 1 (prior art) is an illustration of a reciprocating internal combustion engine serving as a fuel processor for high temperature fuel cells;

FIG. 2 (prior art) is a graph reproduced from E. M. Goodger, Petroleum and Performance in Internal Combustion Engineering, Butterworth Scientific Publications, London, 1953 that shows the exhaust composition of reciprocating engine exhaust as a function of air/fuel ratio;

FIG. 3a illustrates a power plant embodying the invention using two Brayton cycle turbomachines, high-temperature fuel cells and an afterburner to consume depleted product gas;

FIG. 3b illustrates the pressure cycle of the power plant shown in FIG. 3a.

### DETAILED DESCRIPTION OF THE INVENTION

The present invention relates to hybrid energy conversion systems that combine internal combustion engine and fuel cell elements to convert hydrocarbon and alcohol fuels to electric power and shaft power. The present invention is described with respect to Brayton cycle turbomachines. However, it will be obvious to those skilled in the art that the following detailed description is similarly applicable to many types of internal combustion engines including rotary, four stroke Otto cycle reciprocating machines, and two-stroke reciprocating machines.

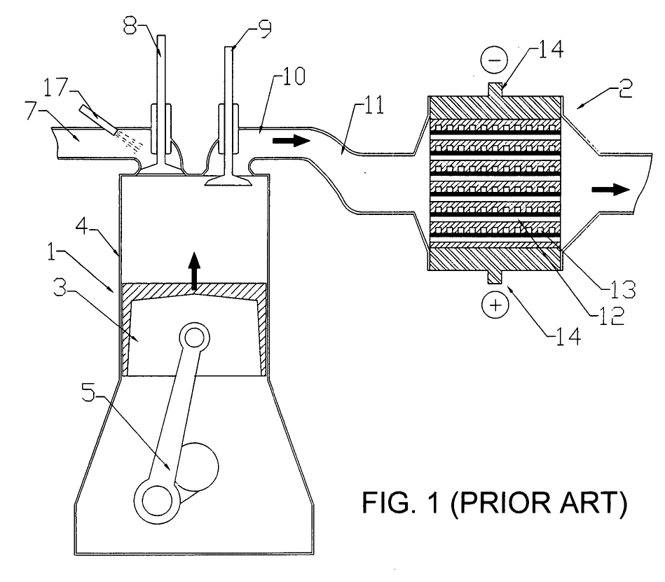

FIG. 1 (prior art) illustrates the ICR operation as described in U.S. Pat. No. 6,502,533. The four-stroke engine shown illustrates the basic operating principles of fuel reforming in other engine types, including Brayton cycle engines, operated in the fuel-rich mode. Four-stroke engine 1 is combined with a high temperature fuel cell stack 2. The piston 3 is reciprocated in the cylinder 4 by the connecting rod and crank assembly 5. The fuel injector 17 adds hydrocarbon or alcohol fuel to the incoming air in the inlet passage 7 forming a rich, homogeneous air/fuel mixture. The inlet valve 8 and the exhaust valve 9 are opened and closed in a timed relationship with the motion of the piston 3 such that air/fuel mixture is drawn in through the inlet passage 7, compressed, ignited, expanded to produce shaft power, and pushed out into the exhaust passage 10 as product gas. The combustible constituents of the product gas include hydrogen, carbon monoxide, and small amounts of hydrocarbons. A duct 11 delivers the product gas to the fuel cell anode passages 12, where its combustible constituents are electrochemically oxidized. Air is passed through the cathode passages 13 where its oxygen is electrochemically reduced. The product gas oxidation and oxygen reduction combine to generate electric power that is collected at terminals 14 connected to the cell anodes and cathodes.

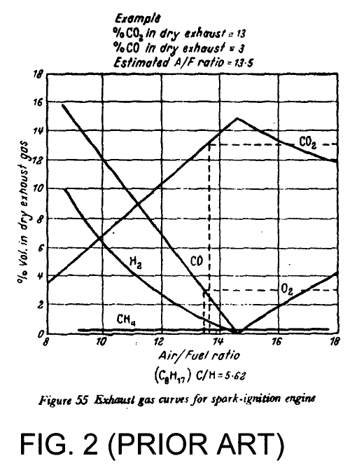

FIG. 2 (prior art) shows the dry exhaust gas composition of a four-stroke reciprocating spark ignition internal combustion engine operating on liquid hydrocarbon fuel at air/fuel ratios both richer and leaner than stoichiometric operation. The results are typical of other internal combustion engine types operated in the fuel-rich mode. At a rich air/fuel ration of 10:1, for example, the exhaust gas fuel components are about 6.5% hydrogen, 12% carbon monoxide, and a faction of a percent methane. Non-fuel gases include about 7% carbon dioxide and 74% nitrogen. The previous quantities are on a dry basis: wet exhaust gas contains about 15% by volume of water vapor. Oxide of nitrogen content is very low because of the strongly reducing environment in rich, homogeneous combustion. The smoke limit, the point at which some excess fuel is converted to soot rather than hydrocarbon monoxide, forms the practical limit to rich operation. In theory, soot formation occurs below an air/fuel ratio of 5.5 for fuel with a stoichiometric ratio of 14.65, but in real internal combustion engines soot formation occurs at higher ratios. According to Houseman, (U.S. Pat. No. 4,041,910) soot-free operation as low as 6.5 can be achieved by a combination of means including addition of water, steam or recycled exhaust to the air/fuel mixture, and vaporizing and thoroughly mixing the fuel with heated air.

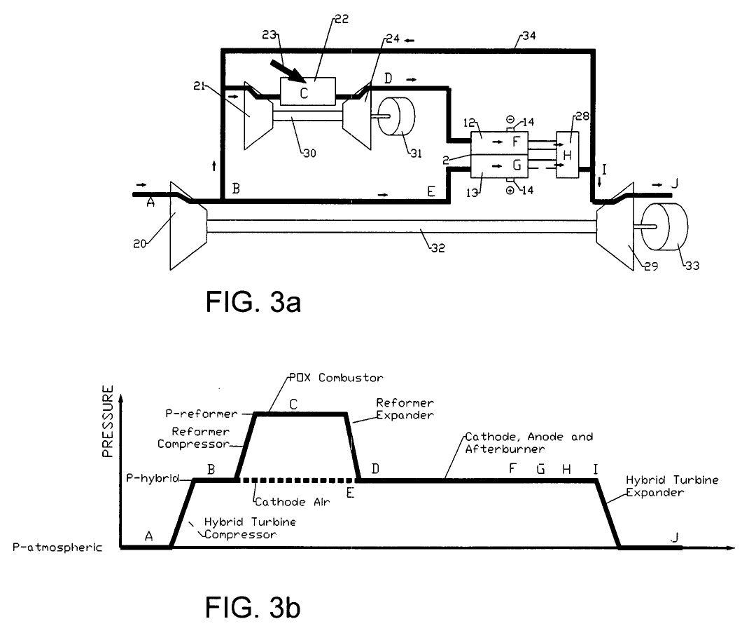

FIG. 3a shows a simplified schematic of a hybrid power generation system according to the present invention. Air at P-atmospheric enters the system through hybrid stage compressor 20 and is raised to P-hybrid. A first portion of the P-hybrid air is raised to P-reformer by reformer stage compressor 21 and delivered to reformer burner 22 where it reacts with fuel stream 23 to produce hot product gas at P-reformer. The product gas expands through reformer stage expander 24 to P-hybrid, and flows through anode chamber 12 in the fuel cell 2. A second portion of the P-hybrid air flows through cathode chamber 13 in the fuel cell 2. Product gas and air electrochemically react in fuel cell 26 to generate electric power that is collected at terminals 14 connected to the cell anodes and cathodes, and are then mixed and burned in afterburner 28 to form a hot exhaust gas stream at P-hybrid. The exhaust gas stream expands through hybrid stage expander 29 to P-atmospheric. A shaft 30 connects reformer stage expander 24 to reformer stage compressor 21 and reformer electrical generator 31 such that reformer stage compressor and generator are driven by product gas flow through reformer stage expander 24. Similarly, shaft 32 connects hybrid stage expander 29 to hybrid stage compressor 20 and hybrid electrical generator 33 such that the hybrid stage compressor and generator are driven by the exhaust gas flow through the hybrid stage expander. Optional exhaust recycle loop 34 carries moisture-laden exhaust from afterburner 28 to the inlet of reformer stage compressor 21 where it mixes with the air entering reformer burner 22. FIG. 3b shows a cycle pressure diagram corresponding to the schematic in FIG. 3a. The details of the process are described using the reference characters A, B, C and so on to designate corresponding points in the schematic and pressure diagram.

A-B Hybrid stage compressor 20 raises ambient air at P-atmospheric to P-hybrid. The air stream splits into the reformer air stream and the cathode air stream.

B-C Reformer stage reformer compressor 21 raises the reformer air stream from P-hybrid to P-reformer in reformer burner 22, where it is mixed with fuel stream 23 to form a rich mixture that burns to produce heat, and a product gas containing H₂ and CO. Exhaust may be recycled from afterburner 28 (I-B) to the reformer air stream through optional exhaust recycle loop 34 to increase the water vapor content in the gas mixture in reformer burner 22 and thereby reduce the tendency for soot formation in the rich combustion process.

C-D The product gas flows through reformer stage expander 24 from P-reformer to P-hybrid, and cools adiabatically while generating shaft power. The shaft power drives reformer stage compressor 21 and reformer electrical generator 31.

D-F The product gas flows over anode 12 of fuel cell 2 where it reacts to generate electric power, in the process depleting the H₂ and CO content.

B-E-G The cathode air stream flows over cathode 13 of fuel cell 2 where it reacts to generate electric power, in the process depleting the O₂ content.

F-H, G-H The depleted cathode and anode streams enter afterburner 28 where they mix and burn.

H-I-J The afterburner exhaust flows through hybrid stage expander 29 from P-hybrid to P-atmospheric, and cools adiabatically while generating shaft power. The shaft power drives the hybrid compressor 20 and hybrid electric generator 33. Sensible heat may be recovered from the exhaust stream to increase the heat utilization.

A power plant is defined as a system that contains all the elements required to convert fuel and air into electric or mechanical power, while the preceding description includes only the major elements necessary to understand the present invention. A thermal management system, supervisory control system, sensors, valves, pumps, blowers, thermal insulation, electric power conditioning and control systems, and enclosures may be required to implement the invention and adapt it to particular applications. Depending on the fuel used and the type of fuel cell employed, sulfur removal means and additional product gas processing and thermal management such as described in U.S. Pat. No. 6,502,533, may be incorporated.

There are no definite upper or lower limits to the output of power plants incorporating the present invention, and output of less than 1000 watts to tens of megawatts is contemplated. Also, a number of machinery arrangements are possible. For example, both the hybrid engine and the reformer turbomachinery may be on the same shaft with one electric generator, rather than on separate shafts as shown. Further, the mechanical shaft power may be used directly rather than to generate electric power.

The foregoing embodiments of the present invention have been presented for the purposes of illustration and description. These descriptions and embodiments are not intended to be exhaustive or to limit the invention to the precise form disclosed, and obviously many modifications and variations are possible in the light of the above disclosure. The embodiments were chosen and described in order to best explain the principle of the invention and its practical applications to thereby enable others skilled in the art to best utilize the invention in its various embodiment and with various modifications as are suited to the particular use contemplated. It intended that the invention be defined by the following claims. The term “air” is used in the claims to designate any gas that contains significant amounts of free oxygen, “system fuel” is used to designate any liquid or gaseous hydrocarbon or alcohol before conversion, and “product gas” is used to designate the reformed fuel gas stream.

1. A hybrid energy conversion system comprising
A. an internal combustion engine operated with a working fluid of air containing system fuel in excess of the stoichiometric quantity, with the result that hydrogen, carbon monoxide, hydrocarbons, reduced sulfur or combinations of the same are present in the internal combustion engine product gas exhaust;
B. one or more fuel cells that produce electric power through electrochemical oxidation of product gas containing hydrogen, carbon monoxide, hydrocarbons, reduced sulfur or combinations of the same at the anode surfaces and reduction of air at the cathode surfaces;
C. gas transfer means to move at least a portion of the product gas from said internal combustion engine to the anode surfaces of said fuel cells;
D. supply means to bring air to the cathode surfaces of said fuel cells;
E. exhaust means to remove spent product gas and air from said fuel cell anode and cathode;
F. compressor means to raise the pressure of said air entering the internal combustion engine and the fuel cells from a first lower to a second higher pressure;
G. afterburner means to mix and combust said spent product gas and air from said fuel cell anode and cathode to form a hot exhaust gas stream at the second higher pressure;
H. Expander means to reduce said hot exhaust gas stream from the second higher pressure to a lower pressure and produce shaft power.

2. The hybrid energy conversion system of claim 1 wherein electric or shaft power produced is utilized to operate said compressor means.

3. The hybrid energy conversion system of claim 1 wherein shaft power produced by the said internal combustion engine and said expander is utilized to generate electric power or perform mechanical work.

4. The hybrid energy conversion system of claim 1 wherein heat transfer devices heat or cool the said internal combustion engine working fluid, internal combustion engine product gas, air supplied to the fuel cell cathode or spent gasses from fuel cell anode and cathode.

5. The hybrid energy conversion system of claim 4 wherein said heat transfer devices are connected such that thermal energy gained from cooling high temperature streams is used to heat low temperature streams.

6. The hybrid energy conversion system of claim 1 wherein the said gas transfer means includes processing means to remove chemical species from the product gas stream.

7. The hybrid energy conversion system of claim 1 wherein the said gas transfer means includes processing means to change the product gas chemical composition.

8. The hybrid energy conversion system of claim 1 wherein the said working fluid is mixed to obtain a substantially homogeneous mixture.

9. The hybrid energy conversion system of claim 1 wherein the said working fluid is heated.

10. The hybrid energy conversion system of claim 1 wherein water, hydrogen, carbon dioxide, carbon monoxide or hydrocarbons are added to the said working fluid.

11. The energy conversion system of claim 10 wherein the said water, hydrogen, carbon dioxide, carbon monoxide or hydrocarbons are contained in depleted product gas recycled from the fuel cell anode.

12. The hybrid energy conversion system of claim 10 wherein the said water and carbon dioxide are contained in gas recycled from the afterburner exhaust.

13. A heat engine using air as a working fluid comprising a compressor that operates to raise air from a lower pressure to a higher pressure, a heat source for heating said compressed air, and an expander that expands said heated compressed air to a lower pressure to produce shaft power, said heat source comprising
A. an internal combustion engine operated with a working fluid composed of a first portion of said compressed air containing system fuel in excess of the stoichiometric quantity, with the result that hydrogen, carbon monoxide, hydrocarbons, reduced sulfur or combinations of the same are present in the internal combustion engine product gas exhaust;
B. one or more fuel cells that produce electric power through electrochemical oxidation of product gas containing hydrogen, carbon monoxide hydrocarbons, reduced sulfur or combinations of the same at the anode surfaces and reduction of air at the cathode surfaces;
C. gas transfer means to move at least a portion of the product gas from said internal combustion engine to the anode surfaces of said fuel cells;
D. supply means to bring a second portion of said compressed air to the cathode surfaces of said fuel cells;
E. exhaust means to remove spent product gas and air from said fuel cell anode and cathode;
F. afterburner means to mix and combust said spent product gas and air from said fuel cell anode and cathode to form a heated gas stream at said higher pressure;
G. gas transfer means to move said heated gas stream to the inlet of said expander.

14. The heat engine of claim 13 wherein said internal combustion engine produces or consumes shaft power.

15. The heat engine of claim 13 wherein a portion of the electric or shaft power produced is utilized to drive said compressor.

16. The heat engine of claim 13 wherein a portion of the shaft power produced is utilized to generate electric power or perform mechanical work.
